(19) United States
(12) Patent Application Publication
(10) Pub. No.: US 2020/0019130 A1
(43) Pub. Date: Jan. 16, 2020

(54) Room Control System

(71) Applicant: Marco Rutzke, Hohenstein-Ernstthal (DE)

(72) Inventor: Marco Rutzke, Hohenstein-Ernstthal (DE)

(21) Appl. No.: 16/336,098

(22) PCT Filed: Sep. 23, 2017
(86) PCT No.: PCT/DE2017/100812

§ 371 Date: Mar. 23, 2019

(30) Foreign Application Priority Data
Sep. 23, 2016 (DE) 102016118059.9
Sep. 21, 2017 (DE) 102017121969.2

(51) Int. Cl. G05B 15/02; G08C 17/02; H04L 12/28

(52) U.S. Cl. CPC G05B 15/02; G08C 17/02; H04L 12/2803; H04L 2012/285; G08C 2201/93; H04L 2012/2849; G05B 2219/26

(57) ABSTRACT

1. Room control system for a room-in-room (6), comprising at least one input unit (1), at least one display unit (2) and a data processing system (3) interacting with the input unit (1) and the display unit (2), where with the data processing system (3) at least one technical device (4) can be selected and at least one service function can be realised with the technical device (4).

### CROSS REFERENCE TO RELATED APPLICATIONS

This application is the U.S. national stage of International Application No. PCT/DE2017/100812, filed on 2017 Sep. 23. The international application claims the priority of DE 102016118059.9 filed on 2016 Sep. 23 and the priority of DE 102017121969.2 filed on 2017 Sep. 21; all applications are incorporated by reference herein in their entirety.

### BACKGROUND

The invention concerns a system for the control of different technical devices for realising different functions in a room-in-room facility.

Room control systems are known in different designs. Technical devices to be allocated to the room, such as especially heating and air conditioning units, washing machines, stoves as well as communication technology to be controlled by means of a connection to a network via smartphones or external computers.

Room-in-room systems are known. They concern a delimited space within existing rooms. Room-in-room systems are known as free-standing, enclosed and independent room modules in large rooms.

The problem with these room-in-room systems is the fact that, although they are available, it is often not clear when and by whom the room-in-room is used or may be used and for which period utilisation is possible in each instance. Furthermore, such room-in-room systems cannot be operated dynamically.

The task of the invention is therefore to make a complex, multifunctionally operable room control system available for a room-in-room.

### SUMMARY

The invention concerns a room control system for operating a room-in-room. At this, technical devices allocated to the delimited room and especially arranged in the room are controlled and user-specific data is provided. With the help of the selectable technical devices, the room control system shall realise different service functions. The room control system shall facilitate the user-friendly input of the requirements for the service functions and address them. Furthermore, the room control system shall be programmable by the users in terms of time. The functions of the room control system shall be controllable for the users.

The task of the invention is to make a complex, multifunctionally operable room control system available for a room-in-room.

Room control system for a room-in-room (6), comprising at least one input unit (1), at least one display unit (2) and a data processing system (3) interacting with the input unit (1) and the display unit (2), where with the data processing system (3) at least one technical device (4) can be selected and at least one service function can be realised with the technical device (4).

### DETAILED DESCRIPTION

When referring to a room so far and below, this concerns a room-in-room in each case as delimited space within existing rooms.

According to the invention, the task is solved by a room control system with the features of the main claim.

The purpose of the invention is to realise different service functions for the room-in-room utilising selectable technical devices.

The room control system includes input units and display units interacting with a data processing system with server functionality. The data processing system processes the data entered, as server or server system, such as target values and their time-related allocations, and selects the respective technical devices according to those defaults. The technical devices realise the respective service functions. The data processing system and server or server system can thus be equated in terms of term and function, since, regardless of the naming, a data processing system or a server or server system is equally suited to meeting the complex task of room control.

The input units are preferably intended and designed to facilitate the setting or programming of different service functions and to enter defaults (target values), preferably with time allocation, as well as other data regarding service functions available in the room. Likewise, the input units can be designed, for example, to enter the operation of the devices affecting the respective service function or the operation of devices that carry out the possible service functions and facilitate programming of the data processing system or to enter data or information, which, for example, shall be displayed during utilisation.

The input units are, for example, switches, keyboards or other input devices for computers, touch-sensitive surfaces or screens, camera systems, microphone systems or optical as well as electronic reading devices and/or mobile or stationary communication devices.

Data entry can take place, for example, by switch operation, keyboard, gesture control, touchscreen or touchpad as well as data transfer from an electronic and mobile or stationary end device, such as smartphone, tablet PC, notebook or PC. Complex switching units can therefore also serve as input units. Likewise, camera systems or electronic reading devices can be used as input units.

The display units are especially intended and designed to display the data entered via input units, status values regarding the technical facilities and the data processing system as well as status value regarding the room-in-room and/or the service function. The display units thus serve especially the control of different functions of the room control system.

Display units may especially be displays but also simple illuminated indicators.

Display units further include, for example, screens or display fields and/or mobile or stationary communication devices inside and/or outside the room-in-room.

Input units and display units are preferably combined in a single device. Combined input and display units may preferably be computers, especially portable computers, such as tablets or smartphones. The respective screens function then as display unit. However, the screens function as input unit at the same time if they are touch-sensitive and allow direct input or input via on-screen keyboards.

The input units and display units are logically connected with the data processing system via data networks. The data processing system includes as hardware at least one, for example, redundant server, integrated in a network (LAN and/or Internet), on which appropriate control is active as software. Ideally, the data processing system is connected with the Internet or at least arranged in a local or private network.

The data processing system may be dedicated, for example, that is, provided and designed as virtual server or, for example, with its own hardware or, for example, provided and designed as server utility as part of another server, for example, an available company server for user data and other utilities.

According to the defaults entered via the input unit the data processing system controls the respective technical devices and possible final control elements, which thereby realise the defaults for associated service functions in the room.

The technical devices include, for this purpose, an interface to the data processing system and, if applicable, integrated control or regulation.

To realise the functionality, the input units, display units and technical devices as well as final control elements for data transmission, are connected with the appropriately configured data processing system and, if applicable, with each other. This allows data exchange according to the configuration of the data processing system in that user input causes a desired selection of the technical devices and final control elements and thereby realisation of the desired service function. Configurations of the data processing system are corresponding system programs where these programs may be predefined or editable.

With the invention, access to different technical devices, interrelated with the room-in-room, becomes possible via a central data processing system where the input of relevant data can be realised via several different input units communicating with the data processing system. Thus, different service functions in the room or for the room, centrally controlled, can thus be realised in a user-friendly manner.

With the invention a complex, multifunctionally operable room control system is made available for a room-in-room.

According to an advantageous design of the invention, the service functions, room functions, access functions may be service functions for the room-in-room or available in the room-in-room.

Room functions especially concern heating, ventilation, air conditioning, lighting and room darkening. The technical devices realising the room functions, such as heating systems, A/C systems, ventilation systems, lighting systems or privacy protection systems are referred to below as room equipment.

Through basically known heating systems, A/C systems and ventilation systems, with or without integrated actual value sensing, the desired values such as temperature or humidity can be realised according to the user preferences for the usage period that can be defined by the user via the input unit.

Analogously, the desired lighting and privacy conditions can be realised through lighting systems or privacy protection systems, such as switchable film or room darkening systems, such as blinds.

In the same way, the technical devices available in the room-in-room and for the access functions of the room-in-room, furthermore referred to as access devices, can be selected via the room control system. Access functions means all functions that allow legitimate access to the room and respective technical devices.

The respective access devices for the access functions are especially implemented through locking systems as well as authorisation systems or respective input units for user identification. The access devices for the realisation of the access functions for access to the room-in-room are in particular respectively designed locking systems, equipped with interface to the data processing system, such as, preferably, appropriate locks.

The locking system thus allows or prevents access to the respective room-in-room. A corresponding locking systems, for example, may enable access for a booked period by entering a code into the corresponding input unit. User identification can also take place by recording biometric data or readable codes. According to the user identification, the access functions controlling access to the room are enabled.

Other access functions concern enabling or locking of technical devices present in the room, such as office equipment, for the respective potential users. Enabling of the office equipment is realised via the authorisation system. Via the data processing system, the authorisation system as office equipment especially controls computer systems, video systems, audio systems and communication systems. The authorisation system may thereby be part of the data processing system.

The access functions correspond, if applicable, with a booking system realised through the data processing system.

Thus, the authorisation system, for example, can control—via a user profile stored in the data processing system—the authorisation for the use of available service functions for the use and/or operation of certain devices, such as computers, projectors, screens but also other machine and devices present in the room.

Service functions refers to functions that are made available to the user through technical devices available in the room as office equipment or devices such as computers, projectors, large displays, audio systems, communication systems or machines, such as printers or computer-controlled machine tools. This allows processing and/or rendering or otherwise using the data entered or installed via the input units by the corresponding office equipment.

The computer systems, video systems, audio systems and communication systems thus provide service functions to offer a service to the users in the room. Thus, these devices can be selected by the input units in advance of a planned use or during such use. For example, a video conference or illustrated lecture by a person not physically present can thus be realised. Likewise, office equipment or office devices such as projectors, large display, loudspeakers or available machines can be used by the users via a portable computer that was brought along using the data communication provided. In addition, user-related data, such as data or user profiles stored at his workplace can be provided and used at the room-in-room.

Another possible service function is the provision of consumables on or in the room-in-room. These may be drinks or snacks and office supplies such as pens, paper or other similar articles. On the one hand, these can be stored in lockable cabinets, refrigerators or material cabinets that can be unlocked via the booking system or authorisation system and via the access function. In addition, it may be provided that the consumables are recorded when they are withdrawn so that, on the one hand, they can be replenished in good time and, on the other, they can be invoiced. This invoicing can be done directly or via the booking system. The detection of the removed material or objects may be carried out by sensors or cameras which detect the objects or applied or applied codes and transmit them to the reservation system and/or the room control system.

The, for example, concerned switches, keyboards or other input devices for computers, touch-sensitive surfaces or screens, camera systems, microphone systems or optical as well as electronic reading devices and/or mobile or stationary communication devices are arranged, according to an advantageous design of the invention, inside and/or outside the room-in-room and connected directly or indirectly with the data processing system via wireless or wired data connections.

Switches hereby include rotary knobs, rocker switches, track balls as well as touch-sensitive surfaces and other known input elements as well as a practical arrangement of different input elements with each other in a single input unit.

Keyboards and touchscreens are especially used as part of mobile communication devices such as smartphones, tablets and portable computers. Input units may also be realised via gesture control, which is recorded by a camera system, or voice control, which is recorded by a microphone system. Thus, requirements, such as target values concerning the service functions, can be entered by the user. Other input units are optical as well as electronic reading devices which scan the identification data of the potential users for user identification and interact with the authorisation system and the locking system. Identification data may hereby constitute biometric data, optical and electronic codes as well as passwords.

The input units, such as switches, keyboards and touchscreens are hereby arranged inside and/or outside the room-in-room. Touchscreens may especially be arranged as operating terminal on the outside and/or inside of the room-in-room to be able to control the room, access and/or service functions. Likewise, they may be designed as external input devices, which are connected with the data processing system via wireless or wired data connections, for example, through immediate or direct data commissioning via data lines or wireless.

The indirect data communication or data connection takes place especially via the Internet or a local network as LAN, WLan or via other wireless technologies.

This allows for the global or at least company-wide input of user requirements on the room control system via the input units, which enables input by the users from inside and/or, as desired, outside the room-in-room.

Local and also worldwide communication of the input units with the data processing system is made possible via respective direct or indirect wireless or wired data connections.

According to another design of the invention, the associated display units, which are, for example, screens or display fields and/or mobile or stationary communication devices arranged inside and/or outside the room-in-room. Preferably, they are arranged at the outside and/or inside of the room-in-room. The display units may hereby be designed, for example, as display or LED indicators.

The output of relevant information to the user, independent of a particular location, is hereby possible via direct or indirect wireless or wired data connections with the data processing system.

Finally, operation, including information output, independent of the present location of the respective user, is possible. Operation can take place both, within the room-in-room and also directly in front of the room regardless of the distance. Thus, operation, monitoring and utilisation of the room control system is possible via one or several external computers or other suitable devices.

According to a design of the invention, at least one final control element is available for the room functions and/or the access functions and/or the service functions available in the room and/or the technical devices. The final control elements are each allocated to the room equipment for the room functions and to the access devices for the access functions. For the service functions available in the room, a final control element is allocated to at least one of the office devices.

The final control elements, equipped with appropriate interfaces to the data processing system, can realise the desired service functions directly or through the selection of corresponding room equipment, access devices and office equipment affecting the service function, via the data processing system.

The final control elements serve, for example, the realisation of room functions, access functions and the realisation of service functions.

The control elements of the room control system are, as examples, motors, valves or controllable switches that act both separately and are assigned to the room equipment for room functions, for instance heating systems, climate systems, ventilations systems, illumination systems, privacy protection systems and/or darkening systems. For example, a drive motor for room darkening blinds may act as final control element.

The final control elements of the access functions are allocated to the access devices, such as locking system and authorisation system.

The appropriately designed final control element may further serve to enable authorised access to the room-in-room as locks with corresponding interface.

A final control element for the access function is preferably a lock with interface to the data processing system, which thus enables the corresponding opening of the door if authorisation is given.

Likewise, final control elements may be allocated to the office equipment for the service functions, such as computer systems, video systems, audio systems and/or communication systems and/or modules for the selection of these systems. The final control element may thus become active, both as independent technical device and also as part of the respective technical device, for example, in that power supply units are designed for remote control or switching allowing operation only if authorised or necessary utilisation is given.

The final control elements through their selection via the data processing system finally realise the desired parameters of the room functions, access functions or service functions in the room.

### BRIEF DESCRIPTION OF THE DRAWINGS

FIG. 1 shows a room control system.

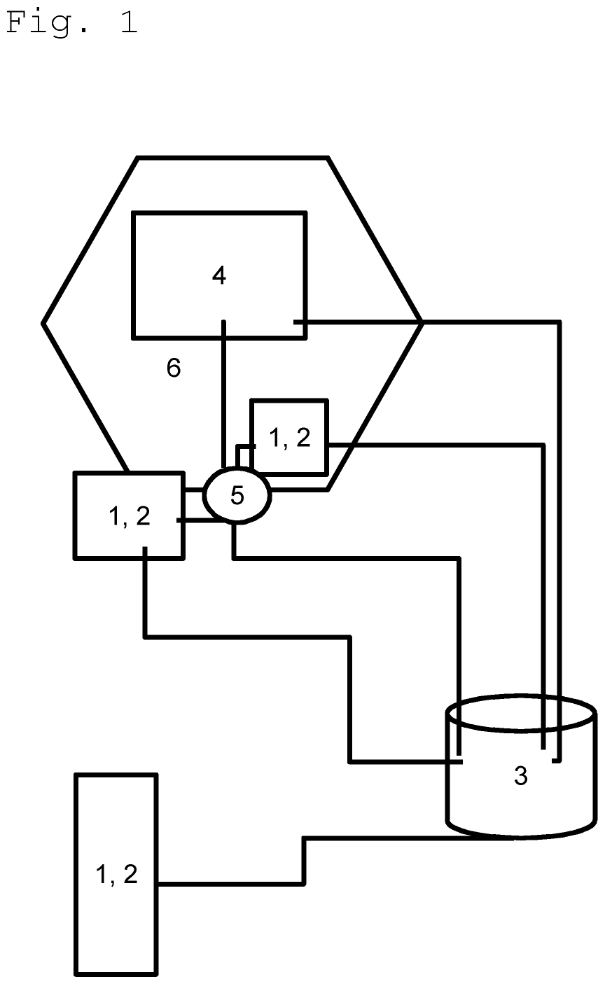

### DETAILED DESCRIPTION OF THE PREFERRED EMBODIMENTS

As advantageous further development of the invention, at least one sensor is connected with at least one input unit and/or at least one display unit and/or with the data processing system and/or with a least one technical device and/or with at least one final control element. In addition or as an alternative, at least one sensor is allocated to at least one service function. The sensor allows the beneficial recording of target values for the service function in a convenient and automated manner. For example, it can be determined in a simple manner through corresponding sensors or sensor groups, whether any at all, which and how many users are present or whether the user/users is/are standing or sitting and that the table height or table size can be changed accordingly. Advantageously, the automatic and independent recording of the number or persons in the room allows determining the air quality, humidity and temperature, adjusting A/C control and fresh air supply via suitable sensors without the active intervention of the users being required.

For this purpose, at least one sensor is arranged inside or outside of the room and, if several sensors are possibly present, they are arranged inside or outside the room-in-room as needed. Certain service functions can thus already be activated when the authorised person approaches.

Detection of the persons can be realised in many different ways, for example, via face recognition, RFID or other transponder systems or by detecting movement during the approach and via thermal images.

If, by contrast, only anonymous sensing of one or any number of persons being present is required, the detection of body-like contours is sufficient.

This detection of contours is also suitable for detecting forgotten objects such as cases, notebooks or other objects and alerting the users accordingly. Especially in public buildings or areas, the danger represented by intentionally or accidentally forgotten objects can possibly be counteracted.

According to a further development of the invention, the room control system is designed for several room-in-rooms corresponding with each other and/or independent room-in-rooms. A room control system, in interaction with the data processing system with normally several input units, output units, final control elements and/or corresponding technical devices, can control the room functions, access functions and/or service functions or several rooms. The design feature has the special advantage that users—if certain rooms are occupied—can be directed to other rooms of the pool, if necessary, which simplifies booking, increases user satisfaction and increases room utilisation.

According to an advantageous design of the invention, the data processing system includes a data storage facility. The data storage facility allows setting up a booking systems and thus a room utilisation plan for the future with respectively stored data. Stored utilisation data can be used for billing. This also allows storing user profiles.

The task of the invention is furthermore solved by providing procedures for the control of room functions via a room control system known from the fixture claims.

The procedure according to the invention provides the input or predefinition of target values and data for the service functions via user input using at least one input unit. The respective target values and data is transferred to the data processing system of the room control system and processed accordingly. According to the needs and requirements, the data processing system controls the final control elements and/or technical devices allocated to the respective service functions.

It is therefore possible with the procedure that the inputs of the user through the associated technical devices realise the desired service functions, such as room functions, access functions and service functions.

The respective user can perform the procedures himself without the intervention of other persons and independent of the time and room of the user's presence.

Thus, room functions such as, in particular, heating, ventilation, air conditioning, lighting, privacy protection and/or room darkening and, if applicable, respective time allocation of the target values, can be specified via user input by at least one input unit. The respective data of the room control system is transferred to the data processing system and compared to schedules and utilisation profiles stored in the data processing system and possibly stored with allocation to a schedule. According to the requirements, the data processing system controls the room equipment or final control elements allocated to the functions. In addition, it is intended to transfer the data online to a display unit allocated to the user. It is thereby possible to control the room equipment that affects the room functions so that a comfortable room climate according to the user specifications is provided by realising respective temperatures, humidity, air exchanges, brightness and privacy conditions in accordance with the user specifications, possibly with time allocation.

The procedure also allows that target values for locking systems and authorisation systems can possibly be predefined with a time allocation via user input through at least one input unit. The target values may especially concern the persons, periods and service functions in the room. These specifications are realised by processing in the data processing system and selection of the corresponding final control element and/or access devices. The procedure thus facilitates, when all prerequisites are in place, legitimised access to the respective room, for example, by unlocking the respective door lock.

Likewise, the procedure allows for the provision and transfer of target values and data to office equipment available in the room-in-room and thus the realisation of the respective service functions. Accordingly, the procedure provides that the data entered, possibly with time allocation, is transferred from one of the input units to the data processing system of the room control system. The data processing system, possibly after corresponding data processing, forwards the data to office equipment available in the room and/or final control elements for service functions, especially computer systems, video systems, audio systems, communication systems and/or machine systems. If applicable, the data can be transferred by the data processing system online to a display unit allocated to the user. This procedure communicates closely with the booking systems that can be implemented in the data processing system. The procedure allows the user to use the devices available in the room, such as projectors, large display, loudspeaker or available machines, such as printers, 3D printers or computer-controlled machine tools. Data communication is possible via a computer brought along, connected with the Internet or relevant network, just as via a stationary computer or other electronic mobile end device. Accordingly, a video conference can be conducted, for example.

According to an advantageous design of the procedure, the data processing system communicates with an input unit located in the room, where the correspondingly designed input unit serves the identification of the user and collects the corresponding personal data. By comparison with existing data, the data processing system determines the personal authorisations, especially for access to the respective room. The respective user can be identified in this manner. The corresponding identification data can be captured by the respective input unit, for example, by entering a password sent to the user, an iris scan, fingerprint scan, ID card, for example, with barcode or QR code or an RFID chip carried along. When the identification data stored in the data processing system match, the locking system upon request as well as the authorisation system by selection of the corresponding final control elements, enable access to the room-in-room and/or the enabled room functions or service functions.

According to a design of the invention it is provided that the data is transferred by the data processing system to a display unit. In addition, it may be intended to transfer the data directly to a display unit allocated to the user. This allows both, input control as well as control of the functions of the room control system. In this case, the display unit can be transferred, for example, to an electronic mobile end devices, the screen of which is then the display unit.

According to an advantageous design of the procedure in accordance with the invention, the data processing system creates an editable user profile via one of the input units and saves it. The user profile allows, for example, to file preferences of the user regarding the room climate. Preferably, this is linked to assigning passwords for identification. The user profiles shortens the input time and/or configuration of the room control system for the user. Furthermore, the authorisation system of the data processing system can access the data of the user profile.

According to an advantageous further development of the invention, a booking system has been implemented into the data processing system, which is created on the associated server. The booking system includes a schedule and facilitates fast and clearly arranged allocation of the users to the rooms. Utilising an allocation table implemented in the data processing system, time allocation of the data is possible via the schedule. If necessary, a comparison against the requirements of other users is performed. Utilisation conflicts can be avoided through such as booking system. In addition, the booking system may be designed to suggest alternative dates and/or alternative rooms to the user in the event of unavailability.

If the room is available and the user authorised, confirmation of the booking can be sent to the user. The procedure thus allows controlling access to the room-in-room by granting usually time-allocated authorisations. The authorisations especially allow opening the locks and release from authorisation from the technical devices allocated in the room.

For example, at the respective time—if necessary, with an advance due to technical constraints—the desired room functions can be made available to the user. The user friendliness of the room control system is improved with the booking system.

According to another design of the invention, it is planned that the data processing system monitors the service function of the room control system and status data is transferred to one of the display units. Interferences can thus be detected and correct early on. Likewise, billing of the room-in-room use is thus possible.

However, for the simplified operation it is intended that input units directly trigger and affect the final control elements or service functions to allow, on the one hand, emergency operation and, on the other hand, provide a backup option in case the data processing system fails. It is practical at this that the final control elements as well as the respective service functions are still monitored by the data processing system or are queried after a possibly required restart or recommissioning to ensure the proper function of the room-in-room.

The invention is presented by means of schematic drawing of a design of the room control system and described in detail below.

The room control system control different room-related service functions to which room functions, access functions and service functions can be allocated for a room-in-room 6.

The room control system consists of at least one input unit 1 letting the user enter the data of his requirements, for example, target values and their time allocation, in the room control system. The input unit 1, for example, is a portable computer 1, 2 in this case or a different communication device and, in the more immediate sense, the keyboard or touchscreen of the portable computer 1, 2 or smartphone or operating screen or an operating terminal inside or outside the room-in-room 6, since it is suitable to realising inputs due to its touch sensitivity. User requirements are entered with the input unit 1 for the respective room-in-room 6 and thus predefined. These user requirements concern service functions which are realised by the technical devices 4 available in the room-in-room 6. The service functions may hereby be allocated to the room functions, access functions and service functions. The technical devices 4 that realise the tasks of the room function are referred to accordingly as room equipment 4. Accordingly, the access devices 4 realise the functions of the access systems and the office equipment 4 the service functions.

The room functions include especially heating, ventilation, air conditioning, lighting, privacy protection and/or room darkening, as well as their corresponding time allocation, if applicable The purpose of these functions is especially to ensure the comfort 6 in the room. In addition, they may contribute to saving energy by temporary lowering of the room temperature and/or shutting off the light or heating or air conditioning.

Another room function is the access function, which preferably includes a booking function and interacts with an authorisation system and a locking system. Respective users and/or an authorised person, such as the manager of the room-in-room 6, have the option at this, of entering requirements and target values via the input unit 1 for the locking systems and authorisation functions that carry out the access function with time allocation. This utilisation includes a booking function for reserving the room-in-room 6 and associated service functions. One and/or several special input units 1 may also be designed to identify and thus possibly legitimise the user by entering passwords, recognising biometric features and/or reading optical and electronic codes. They are preferably placed at the entrance of the room-in-room 6, for example, next to the door.

The input units 1 may also be designed to be able to send and possibly receive the data via wireless standards, for example, NFC or transponders (e.g. RFID).

Furthermore, entry or installation of data is possible via one of the input units 1, allowing the use of respective office equipment 4, arranged in room-in-room 6, for realising service functions. The input units 1 may be arranged, both in the room-in-room 6, outside the room-in-room 6 or also via the Internet. Input is therefore possible regardless of the room. The corresponding service functions are provided through office equipment 4, such as computer systems, video systems, audio systems and/or machine system utilising this data. For example, data on a data medium can thus be displayed on a projector or printed on a printer.

Furthermore, the room control system includes display units 2. Here, for example, the screen of a portable computer 1, 2 serves as display unit 2. The portable computers 1, 2 thus realise here the input unit 1 as well as the display unit 2. The display unit 2 by displaying the data thus supports the operation of the room control system. Likewise, display unit 2 also serves as status indicator regarding, for example, the room temperature, humidity and utilisation period. Wall and glass surfaces for displays can also be used as display units 2, for example, through office equipment 4 designed accordingly. The walls and glass surface may thereby already contain these display units 2 or serve as projection area for the display.

Furthermore, the operating screens or operating terminals inside or outside the room-in-room, provided for the input unit 1, also serve as display units 2.

The data entered via input units 1 is forwarded to the data processing system 3 of the room control system. On the hardware side, the data processing system 3 includes at least one network, preferably, a corporate network or server connected with the Internet, and a control software. The data processing system 3 processes the data input and saves them, if applicable. For example, a time allocation table is prepared. At the fixed time and, if applicable, with a practical lead time, the corresponding final control elements 5 and/or room equipment 4, is selected for heating, ventilation, lighting and/or the access devices. Likewise, the data processing system 3 can forward corresponding data to the office equipment 4 available in the room-in-room 6 to carry out service functions such as projectors, separate computers or printers, allowing them to thus be used. For office equipment 4 with a lead time or ramp-up time, they can be switched on or started already in due time before their use.

Beyond this, direct access to room functions and service functions without including the data processing system 3 continues to be possible by operating the respective final control elements 5 such as switches, control valves and by utilising interfaces to corresponding room equipment 4, such as office equipment 4.

In one design example, a sensor is present within the room-in-room 6, which determines not only the temperature but also humidity and percentage of carbon dioxide in the room-in-room and then adjusts air conditioning and fresh air supply. In addition, the sensor also determines the number of persons in the room by thermal image scanning.

A motion detector and light sensor outside of the room-in-room 6 also detect whether persons are present in the room or in the area outside the room-in-room 6 so that the room is illuminated for representation purposes or the windows are animated while when persons are absent, it is switched to stand-by mode to save energy.

The sensor inside the room-in-room 6 is connected with the input unit 1 inside the room-in-room 6. According to the detection of the sensor in the room-in-room 6, the room equipment 4 is selected via the data processing system 3 to change the room function for ventilation, heating or air conditioning. The parameters recorded are transferred via input unit 1 to the data processing system 3 and the output unit 2 inside the room-in-room 6. Input unit 1 and output unit 2 at this are a touchscreen arranged on the inside wall of the room-in-room 6.

The sensor outside the room is directly connected with the data processing system 3. The data processing system 3 is also used—in addition to the room equipment 4 for lighting and heating or cooling and ventilation—to select the access control devices 4, which must become operational from the energy-saving mode only when approached.

For the provision of consumables at or in room-in-room 6, lockers are available as cabinets (not shown), for example, which are activated via the booking system or authorisation system as well as via the access function. Drinks, snacks and office materials are stored in the lockers and supplementary operating devices or input devices 1 for room technology equipment 4 and office technology equipment 4 are stored. It is planned that the consumables as well as the operating devices or input devices 1 are recorded by sensors and cameras during removal, so that, on the one hand, refilling can take place in good time and, on the other hand, billing can take place and that, in addition, it can be monitored that the operating devices or input devices 1 are deposited again after use and are not left behind or even taken away. Recording and billing are carried out via the booking system, the room control system 3.

Utilising the system for the control of different technical devices to realise different functions in a room as room-in-room 6 permits diverse uses in the commercial office environment as well as in public access buildings. Examples are room-in-rooms 6 for meetings or offices or also resting rooms at airports or protected areas in the industrial environment. This invention can be employed and utilised in the industrial environment.

### LIST OF REFERENCE NUMERALS

1—input unit, portable computer
2—display unit, portable computer
3—data processing system
4—technical devices, room equipment, office equipment,
5—final control element
6—room-in-room, room

1. Room control system for a room-in-room (6), comprising at least one input unit (1), at least one display unit (2) and a data processing system (3) interacting with the input unit (1) and the display unit (2), where with the data processing system (3) at least one technical device (4) can be selected and at least one service function can be realised with the technical device (4).

2. Room control system, according to claim 1 characterised in that,
the service function constitutes a room function, and access function and/or a service function available in the room-in-room (6).

3. Room control system, according to claim 1, characterised in that
the input units (1) and/or display units (2) are arranged inside and/or outside the room-in-room (6) and/or connected with the data processing system (3) directly or indirectly via wireless or wired data connections.

4. Room control system, according to claim 1,
characterised in that
the input units (1) and/or display units (2) are connected with each other.

5. Room control system, according to claim 1,
characterised in that
for the realisation of the room function and/or the realisation of the access function and/or the realisation of the service functions available in the room-in-room (6) at least one final control element (3) is available at the respective technical devices.

6. Room control system, according to claim 1,
characterised in that
That with the at least one input unit (1) and/or at least one display unit (2) and/or the data processing system (3) and/or the at least one technical device (4) and/or the at least one final control element (3) at least one sensor is connected where the at least one service function is allocated to at least one sensor where the at least one sensor is located inside and/or outside the room-in-room (6).

7. Room control system, according to claim 1,
characterised in that
the room control system is designed for several corresponding and/or independent rooms (6).

8. Room control system, according to claim 1,
characterised in that
The data processing system (3) includes a data storage facility.

9. Procedure for the control of service functions, such as room functions, access functions and service functions for a room-in-room (6) via a room control system according to claim 1,
characterised in that
target values and data for the service functions are entered or specified by user input via at least one input unit (1) and/or or one sensor,
the corresponding target values and data is transferred to the data processing system (3) of the room control system,
the data processing system (3) process the target values and data (if applicable) and
the final control elements (5) and/or technical devices (4) realising the service function are selected via the data processing system (3) as required.

10. Method according to claim 9,
characterised in that
the identification data of the users is recorded via an input unit (1) for the authorisation system located inside and/or outside the room-in-room (6).
the respective identification data is transferred to the data processing system (3) of the room control system and that the data processing system (3) by comparison with existing data determines authorisations and according to the determined
authorisations selects final control elements (5) and/or room equipment (4) for the room function, the access control devices (4) for the locking function and/or the office equipment (4) for the service functions.

11. Procedure for the control of room functions according to claim 9,
characterised in that
the target values and data is transmitted by the data processing system (3) to at least one display unit (2).

12. Procedure for the control of room functions according to claim 9,
characterised in that
by entering via one of the input units (1) the data processing system (3) generates and stores an editable user profile from user-specific target values and/or selects technical devices (4) according to the allocated user profile.

13. Procedure for the control of room functions according to claim 9,
characterised in that
the data processing system (3) compares the entered target values and/or data with existing schedules and utilisation profiles and, if applicable, allocates them to a schedule and saves them and selects the final control elements (5) that realise the service functions and/or technical devices (4) in accordance with the allocated schedule.

14. Procedure for the control of room functions according to claim 9,
characterised in that
the data processing system (3) monitors the service functions of the room control system and status data is transferred to at least one of the display units (2).
